(19) United States
(12) Patent Application Publication
(10) Pub. No.: US 2019/0241120 A1
(43) Pub. Date: Aug. 8, 2019

(54) BRAKE LIGHT SYSTEMS FOR VEHICLES

(71) Applicant: Ford Locey, Lehi, UT (US)

(72) Inventor: Ford Locey, Lehi, UT (US)

(21) Appl. No.: 16/390,341

(22) Filed: Apr. 22, 2019

(51) Int. Cl. B60Q 1/44; B60T 8/32; B60Q 1/00

(52) U.S. Cl. CPC B60Q 1/444; B60Q 1/0011; B60T 8/329

(57) ABSTRACT

Brake light systems for a vehicle including an array of lights attached to the vehicle, an accelerometer configured to measure a magnitude of deceleration of the vehicle and to transmit a deceleration signal communicating the magnitude of deceleration of the vehicle, and a controller in electronic communication with the array of lights and the accelerometer, the controller including computer executable instructions for activating one or more lights in the array of lights based on the deceleration signal received from the accelerometer, wherein the number of lights activated corresponds to the magnitude of deceleration of the vehicle. In some examples, the brake light system includes a brake pedal sensor configured to detect when a brake pedal of the vehicle is pressed and to transmit a pedal engaged signal communicating that the brake pedal has been pressed.

### BACKGROUND

The present disclosure relates generally to brake light systems for vehicles. In particular, brake light systems communicating information related to the intensity at which the vehicle is braking are described.

Brake light systems on passenger vehicles serve the important role of communicating that a vehicle is braking to other vehicles. Advising other vehicles that a vehicle is braking, especially to other vehicles following the vehicle, is important for avoiding accidents and for the efficient flow of traffic. A typical brake light system includes brake lights positioned at the rear of a vehicle and electronics for turning on the brake lights when a driver presses the brake pedal.

Known brake light systems are not entirely satisfactory tor the range of applications in which they are employed. For example, existing brake light systems communicate only a binary message: the vehicle is braking or it is not. This binary message fails to communicate important information about the manner of braking. For example, conventional brake light systems fail to communicate the magnitude at which the vehicle is decelerating. Without a visual indication of how intensely a vehicle is braking, drivers of other vehicles may misjudge how quickly a vehicle is slowing down or stopping and may in turn fail to properly adjust their own speed or maneuver their vehicles appropriately.

Thus, there exists a need for brake light systems that improve upon and advance the design of known brake light systems. Examples of new and useful brake light systems relevant to the needs existing in the field are discussed below.

### SUMMARY

The present disclosure is directed to brake light systems for a vehicle including an array of lights attached to the vehicle, an accelerometer configured to measure a magnitude of deceleration of the vehicle and to transmit a deceleration signal communicating the magnitude of deceleration of the vehicle, and a controller in electronic communication with the array of lights and the accelerometer, the controller including computer executable instructions for activating one or more lights in the array of lights based on the deceleration signal received from the accelerometer, wherein the number of lights activated corresponds to the magnitude of deceleration of the vehicle. In some examples, the brake light system includes a brake pedal sensor configured to detect when a brake pedal of the vehicle is pressed and to transmit a pedal engaged signal communicating that the brake pedal has been pressed.

### BRIEF DESCRIPTION OF THE DRAWINGS

FIG. 1 is a front view of a brake light system mounted to a rear portion of a vehicle, the brake light system including an array of lights arranged in a row with two lights in the array of lights illuminated.

FIG. 2 is a schematic view of the brake light system shown in FIG. 1 depicting the array of lights, an accelerometer, and a controller with four lights in the array of lights illuminated

FIG. 3 is a front view of a second embodiment of a brake light system, the brake light system including an array of lights arranged in concentric circles.

FIG. 4 is a flow diagram representing a first method defined by computer executable instructions processed by a controller for activating one or more lights in an array of lights.

FIG. 5 is a flow diagram representing a second method defined by computer executable instructions processed by a controller for activating one or more lights in an array of lights.

### DETAILED DESCRIPTION

The disclosed brake light systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, tor the sake of brevity, each and every contemplated variation is not individually described in the following detailed description.

Throughout the following detailed description, examples of various brake light systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Brake Light System

The brake light systems described herein function to communicate braking information of one vehicle to other vehicles. In particular, the present brake light systems communicate not only that the vehicle is braking, but also how aggressively the vehicle is braking. With more specificity, the brake light systems described below provide an indication of a vehicle's magnitude of deceleration.

The reader will readily appreciate that the present brake light systems address a key limitation of conventional brake light systems; namely, inadequate information about the mariner in which a vehicle is braking. Unlike conventional brake light systems that communicate only a binary message of braking or not braking, the brake light systems described here provide information about the magnitude of the vehicle's deceleration.

Knowing the magnitude at which a vehicle is decelerating can be crucial for other drivers to effectively respond to a vehicle's braking maneuver. Indeed, the present brake light systems providing another driver with an indication of the magnitude of deceleration enables the other driver to brake with sufficient intensity to avoid a collision. Additionally or alternatively, the deceleration magnitude information may help the other driver decide that maneuvering around the braking vehicle is best or necessary. Moreover, other drivers receiving an indication of how aggressively a vehicle is braking may help the overall flow of traffic proceed more effectively.

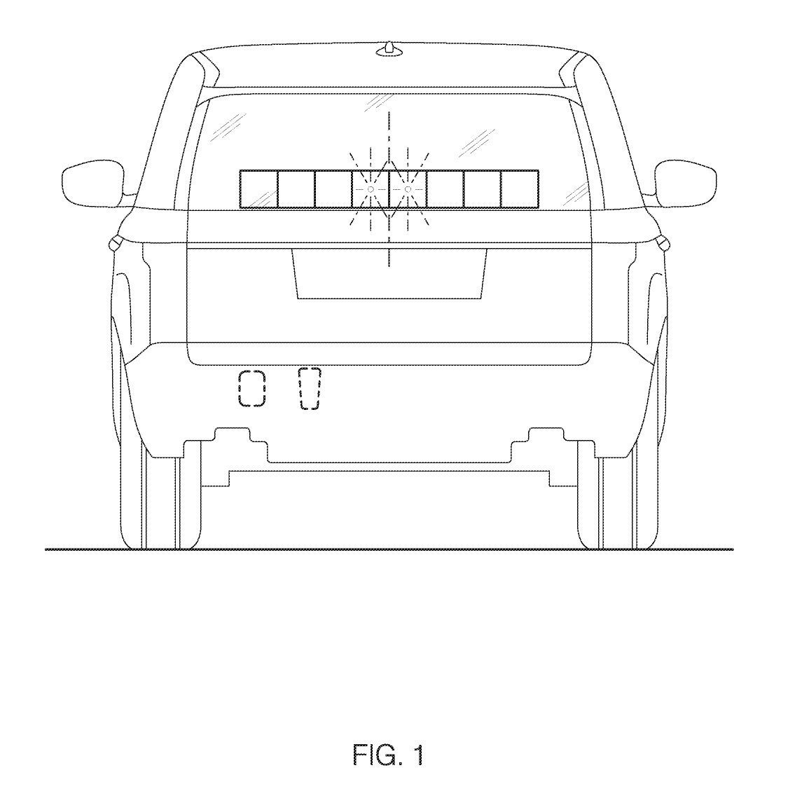

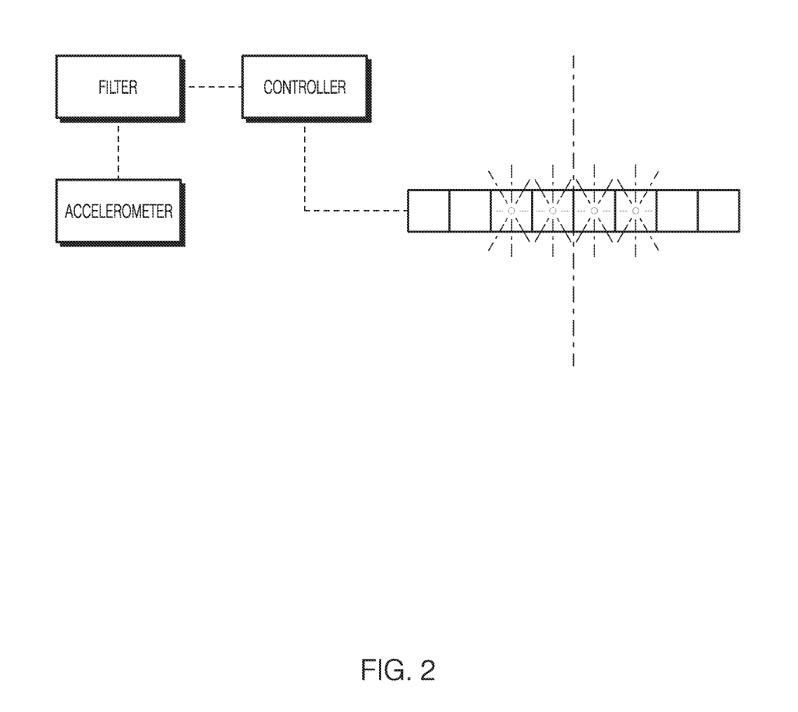

With reference to FIGS. 1 and 2, a first example of a brake light system, brake light system 100, will now be described. Brake light system 100 is installed on a vehicle 102, which includes a gas pedal 127 and a brake pedal 128. Brake light system 100 includes an array of lights 104, an accelerometer 106, a controller 108, a filter 124 and a brake pedal sensor 129. In other examples, the brake light system includes an array of lights, an accelerometer, and a controller without a filter 124 and a brake pedal sensor 129.

### Vehicle

The brake light systems described herein are suitable for use on any type of vehicle. Vehicle is intended to be broadly defined to include passenger and commercial automobiles, trucks, motorcycles, scooters, go-karts, tractors, and any other form of land vehicle. In addition to land vehicles, suitable vehicles include boats and airplanes. Another type of suitable vehicle is human powered machines, such as unicycles, bicycles, tricycles, scooters, and the like. In the present disclosure, vehicle 102 is a standard transmission passenger vehicle with gas pedal 127 and brake pedal 128 as just one common example of a vehicle suitable for the present brake light systems.

### Array of Lights

Array of lights 104 is attached to vehicle 102 on a rear facing portion of vehicle 102, in particular on the rear window of vehicle 102. Any currently known or later developed means for attaching the array of light to the vehicle may be used. The placement of array of lights 104 is selected to make array of lights 104 visible to other vehicles. Other locations would also be effective. For example, the array of lights could be mounted on the rear gate, the rear bumper, incorporated into the taillights, or could be the taillights themselves.

While rear positions are effective to make the array of lights visible to drivers in vehicles behind vehicle 102, other additional or alternative placement locations are also suitable. For example, the array of lights could be mounted on the sides of the vehicle, on the top of the vehicle, or near the front of the vehicle. The reader should understand that the brake light systems described herein are not limited to a single array of lights and multiple arrays could be used. Indeed, in some examples, multiple arrays of lights communicating braking intensity information are mounted to the vehicle in positions visible from almost any position relative to the vehicle, such as in front of the vehicle, to either side of the vehicle, and behind the vehicle.

In the example shown in FIGS. 1 and 2, array of lights 104 is comprised of light emitting diodes. In other examples, different types of lights are used, such as incandescent bulbs. The array of lights may include any currently known or later developed type of light. The lights may be any color or combination of colors desired or necessary to comply with applicable rules governing brake light systems.

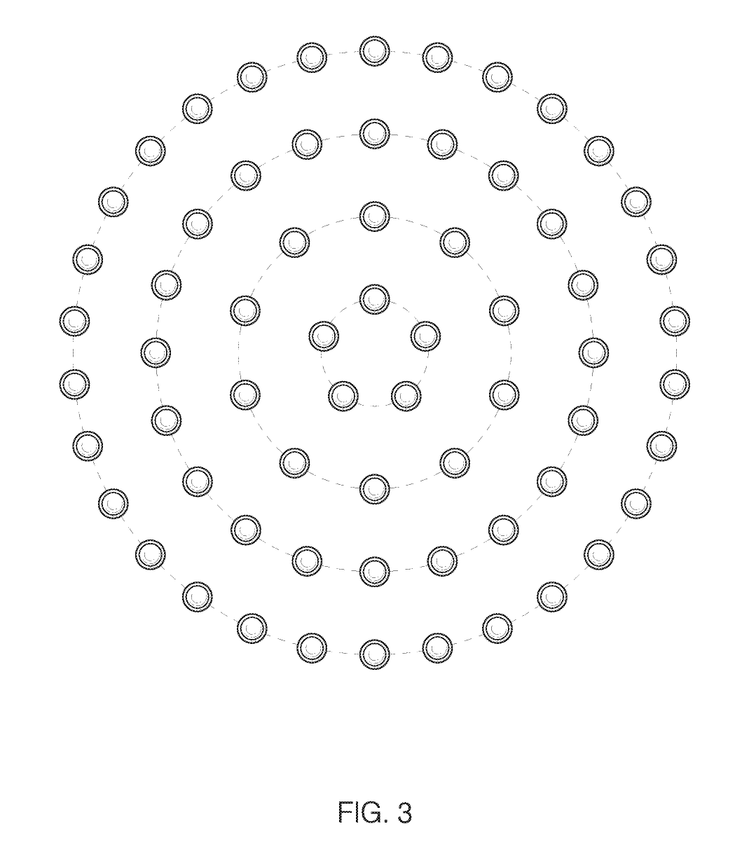

As can be seen in FIGS. 1 and 2, array of lights 104 is arranged in a row 110 with a first section 114 adjacent to a second section 116 with an imaginary midline 112 between them. In other examples, the array of lights is arranged in other configurations. For example, as shown in FIG. 3, an array of lights 204 is arranged in concentric rings about an imaginary center point 234. Array of lights 204 includes a first ring of lights 230 closest to center 234 and a second ring of lights 232 radially spaced from first ring of lights 230 and with a larger circumference than first ring of lights 230.

A wide variety of other configurations for array of lights are contemplated. Other suitable configurations for the array of lights include concentric triangles, concentric rectangles, X-shaped configurations, or irregularly shaped configurations of lights. In certain examples, the array of lights is arranged to selectively display numbers and text by illuminating certain lights in the array.

Returning attention to the example shown in FIGS. 1 and 2, first section 114 and second section 116 each have an equal number of lights, in particular, four lights. In other examples, the first and second sections have a different number of lights.

The reader should understand that each light in array of lights 104 may be a light panel comprised of a plurality of smaller lights. Different number of lights may be selected for the light panels for different illumination intensities. The discussion above will use the term lights to mean a segment of the array of lights that may be illuminated separately from the other segments, whether that segment is made up of an individual light or multiple lights to define a light panel.

With reference to FIGS. 1 and 2, the reader can see that array of lights 104 includes a first inner light 118 closest to midline 112 in first section 114 and a second inner light 120 closest midline 112 in second section 116. One segment further away from midline 112 than first inner light 118 in first section 114 is a next adjacent light 122. In turn, one segment further away from midline 112 than second inner light 120 in second section 116 is a next adjacent light 123.

### Accelerometer

Accelerometer 106 is configured to measure a magnitude of deceleration of vehicle 102. The magnitude of deceleration is a measure of the intensity at which the vehicle is decelerating or braking. In absolute terms, a larger magnitude of deceleration indicates that a vehicle is braking more intensely, that is, coining to a stop in less time, than a vehicle braking with a smaller magnitude of deceleration. A second vehicle traveling behind a first vehicle braking with a large magnitude of deceleration would need to reduce its speed faster or abruptly maneuver around the first vehicle than it would otherwise need to if the first vehicle was braking with a relatively smaller magnitude of deceleration.

Accelerometer 106 is further configured to transmit a deceleration signal communicating the magnitude of deceleration of vehicle 102 to controller 108. Any currently known or later developed type of accelerometer may be used. The deceleration signal may be any currently known or later developed form of signal interpretable by controllers, microprocessors, switches, and the like.

### Filter

With reference to FIGS. 1 and 2, the reader can see that filter 124 cooperates with accelerometer 106 to reduce noise in the measurement of the magnitude of deceleration of vehicle 102. Reducing noise in the deceleration magnitude measurement helps to establish more meaningful and consistent deceleration magnitude values at each sampling interval by reducing or avoiding noise signals not accurately representing the vehicle's actual magnitude of deceleration. Any currently known or later developed type of filter may be used.

### Controller

As shown schematically in FIGS. 1 and 2, controller 108 is in electronic communication with array of lights 104, accelerometer 106, filter 124, and brake pedal sensor 129. The controller may be any currently known or later developed form of controller and include all manner of components known to facilitate controller functions, such as microprocessors, switches, memory, displays, ports, audio output devices, and the like. The controller may further include computer executable instructions in any language, format, or type suitable for interacting and instructing other components in the brake light system.

Controller 108 includes computer executable instructions for activating one or more lights in array of lights 104 based on the deceleration signal received from accelerometer 106. In particular, the computer executable instructions are configured to activate a selected number of lights based on the magnitude of deceleration of vehicle 102. That is, the instructions specify to activate a selected number of lights in proportion to the magnitude of deceleration of vehicle 102.

In the example shown in FIGS. 1 and 2, the instructions specify to activate more lights die higher the magnitude of deceleration. In other examples, the instructions specify to decrease the number of lights activated the higher the magnitude of deceleration, such as starting With all lights activated at small magnitudes of deceleration and decreasing the number of lights activated in proportion to the magnitude increasing.

In the example presented in FIGS. 1 and 2, the computer executable instructions for activating one or more lights in array of lights 104 includes instructions for activating the lights in both first section 114 and second section 116 concurrently. More specifically, the instructions in the brake light system 100 example specify to activate lights in a predetermined activation order. In other examples, the instructions specify to activate lights in one section independent of the other section.

As can be seen in the progression from FIG. 1 to FIG. 2, the predetermined activation order specified is to first simultaneously activate a first inner light 118 closest to midline 112 in first section 114 and a second inner light 120 closest midline 112 in second section 116. The next step in the predetermined activation order in FIGS. 1 and 2 is to simultaneously activate a next adjacent light 122 and 123 in each of first section 114 and second section 116, respectively. The activation order continues in a series of successive light activations in both first section 114 and second section 116 successively more distal from midline 112.

Turning briefly to the example shown in FIG. 3, the computer executable instructions in the FIG. 3 example for activating one or more lights in array of lights 204 is also based on the deceleration signal received from the accelerometer. In the FIG. 3 example, the instructions specify to activate only first ring of lights 230 when the magnitude of deceleration is below a predetermined threshold. The instructions further specify to activate both first ring of lights 230 and second ring of lights 232 when the magnitude of deceleration is at or above the predetermined threshold.

In the example shown in FIGS. 1 and 2, controller 108 includes a preset maximum magnitude of deceleration value stored in memory and a preset minimum magnitude of deceleration value stored in memory. Controller 108 further includes computer executable instructions for apportioning the difference between the present maximum magnitude of deceleration and the present minimum magnitude of deceleration into a set of deceleration intervals. The computer executable instructions for activating one or more lights in array of lights 104 includes instructions for activating lights in the first section and the second section based on how many deceleration intervals are needed to equal or exceed the magnitude of deceleration in the signal received by controller 108 from accelerometer 106.

In the present example, the number of deceleration intervals in the set of deceleration intervals corresponds to the number of lights in array of lights 104. In the example shown in FIGS. 1 and 2, array of lights 104 includes four lights in each of first section 114 and second section 116 and there are four deceleration intervals in the set of deceleration intervals.

In other examples, the number of deceleration intervals does not correspond to the number of lights in the array of lights, but instead is a number selected to communicate magnitudes of deceleration with a desired level of granularity. In examples where the number of deceleration intervals does not correspond to the number of lights in the array of lights, additional and alternative methods beyond the number of lights activated are used to communicate how many deceleration intervals are needed to equal the magnitude of deceleration. In some examples, the intensity of light or the color of light is used to communicate the magnitude of deceleration.

### Brake Pedal Sensor

As shown in FIGS. 1 and 2, brake pedal sensor 129 is configured to detect when a brake pedal 128 of vehicle 102 is pressed. Brake pedal sensor 129 is further configured to transmit a pedal engaged signal communicating that brake pedal 128 has been pressed to controller 108. The brake pedal sensor may be any conventional or later developed type of sensor for detecting when a pedal has been engaged, whether by contact, motion, visual indication, or a combination thereof.

Cooperating with brake pedal sensor 129, controller 108 includes computer executable instructions for activating one or more lights in array of lights 104 based on receiving a signal communicating that a brake pedal 128 of vehicle 102 has been pressed. In the present example, the computer executable instructions specify to simultaneously activate only first inner light 118 closest to midline 112 in first section 114 and second inner light 120 closest midline 112 in second section 116 when receiving a signal communicating that a brake pedal 128 has been pressed.

Additionally or alternatively, the computer executable instructions for activating one or more lights in array of lights 104 may include instructions for activating selected lights in array of lights 104 when controller 108 receives the signal communicating that brake pedal 128 of vehicle 102 has been pressed and the magnitude of deceleration communicated to controller 108 by accelerometer 106 is below a pre-determined threshold. In examples where the array of lights is configured as a row, such as shown in FIGS. 1 and 2, the selected lights may be the lights closest to the imaginary midline. In examples where the array of lights is configured as a series of concentric rings, such as shown in FIG. 3, the selected lights may be the lights in a ring closest to an imaginary center point, such as a first ring 230 proximate center point 234 as shown in FIG. 3.

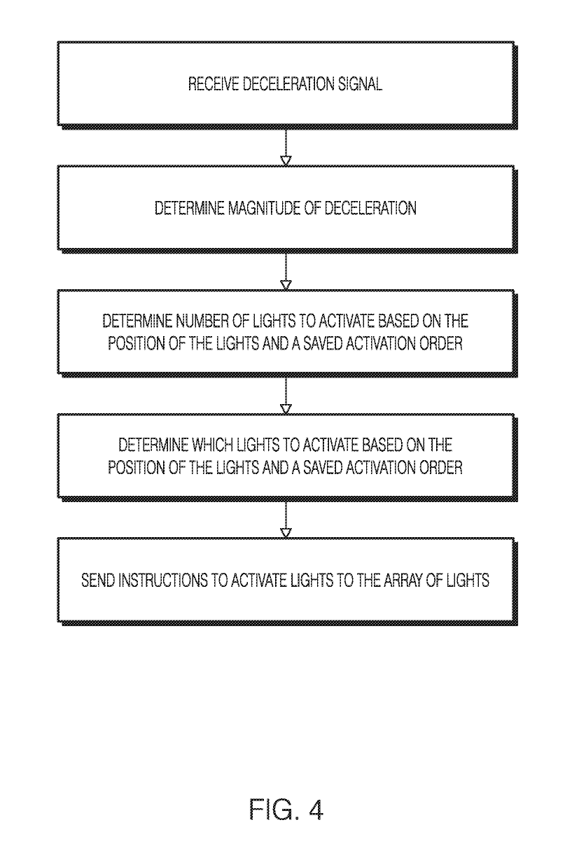

Turning attention to FIG. 4, a method 300 defined by computer executable instructions followed by a controller will now be described. At step 302 of method 300, the controller receives a deceleration signal from an accelerometer cooperating with a filter to reduce noise in the signal. The controller uses the signal to determine a magnitude of deceleration at step 304.

At step 306, the controller determines the number of lights in the array of lights to activate and, at step 308, determines which lights to activate. To determine the number of lights to activate and which particular lights to activate, the controller considers the position of the lights in the array of lights and a predetermined activation order saved in memory. After determining the number of lights to activate and which particular lights to activate, the controller sends a light activation signal to the array of lights at step 310.

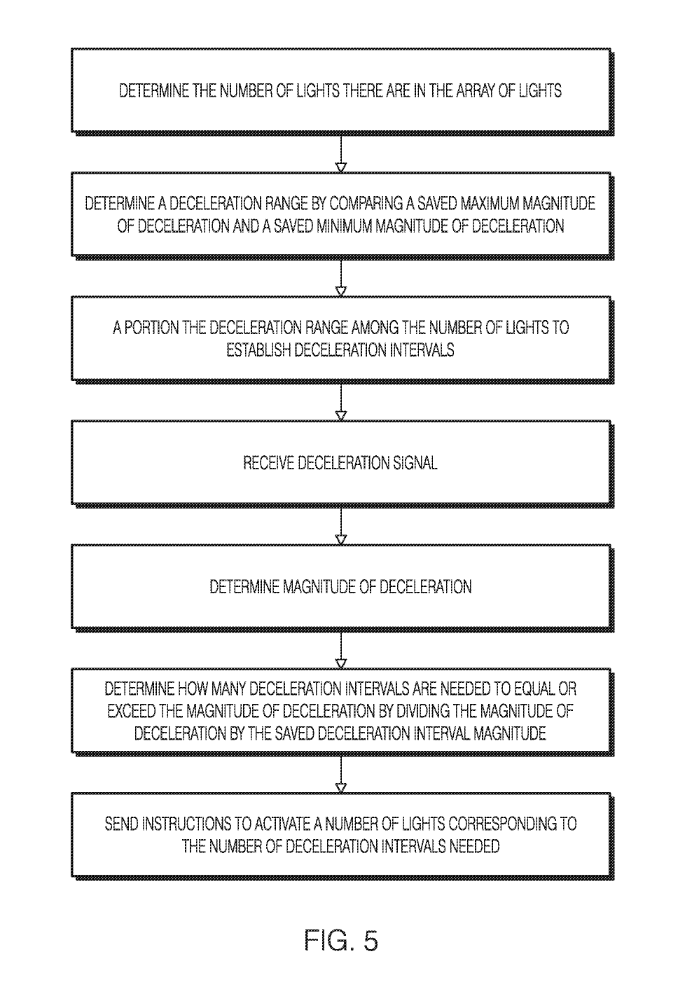

An additional or alternative method defined by computer executable instructions and followed by a controller, method 400, is shown in FIG. 5. At step 402 of method 400, the controller determines the number of lights there are in the array of lights. In some examples, the controller accesses saved information describing the number of lights in the array to determine the number of lights. In other examples, the controller electronically detects the number of lights in the array through start-up diagnostic routines.

At step 404, the controller determines a deceleration range. The controller determines the deceleration range by comparing a saved maximum magnitude of deceleration with a saved minimum magnitude of deceleration. In one example, the controller evaluates the difference between the saved maximum magnitude of deceleration and the saved minimum magnitude of deceleration to determine the deceleration range. At step 406, the controller apportions the deceleration range among the number of lights to establish deceleration intervals.

At step 408, the controller receives a deceleration signal from an accelerometer cooperating with a filter to reduce noise in the signal. The controller uses the signal to determine a magnitude of deceleration at step 410.

At step 412, the controller determines how many deceleration intervals are needed to equal or exceed the magnitude of deceleration. In the method 400 example, the controller determines how many deceleration intervals are needed by dividing the magnitude of deceleration by the saved deceleration interval magnitude. In other examples, other calculations are used to determine how many deceleration intervals are needed.

At step 414, the controller sends instructions to activate a number of lights to an array of lights. In the present example, the instructions specify to activate a number lights corresponding to the number of deceleration intervals needed.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A brake light system for a vehicle comprising:
an array of lights attached to the vehicle;
an accelerometer configured to measure a magnitude of deceleration of the vehicle and to transmit a deceleration signal communicating the magnitude of deceleration of the vehicle; and
a controller in electronic communication with the array of lights and the accelerometer, the controller including computer executable instructions for activating one or more lights in the array of lights based on the deceleration signal received from the accelerometer;
wherein the number of lights activated corresponds to the magnitude of deceleration of the vehicle.

2. The brake light system of claim 1, wherein the computer executable instructions for activating one or more lights in the array of lights includes instructions for activating a selected number of lights in proportion to the magnitude of deceleration of the vehicle.

3. The brake light system of claim 1, wherein:
the array of lights is disposed in a row;
the row has a midline dividing the array of lights into a first section and a second section; and
the first section and the second section have an equal number of lights.

4. The brake light system of claim 3, wherein the computer executable instructions for activating one or more lights in the array of lights includes instructions for activating the lights in both die first section and the second section concurrently.

5. The brake light system of claim 4, wherein the computer executable instructions for activating one or more lights in the array of lights includes instructions for activating lights in a predetermined activation order.

6. The brake light system of claim 5, wherein the predetermined activation order is to first simultaneously activate a first inner light closest to the midline in the first section and a second inner light closest the midline in the second section and then to simultaneously activate a next adjacent light in each of die first section and the second section in a series of successive light activations in both the first section and the second section successively more distal from the midline.

7. The brake light system of claim 3, wherein
the controller includes:
a preset maximum magnitude of deceleration value stored in memory;
a preset minimum magnitude of deceleration value stored in memory; and
computer executable instructions tor apportioning the difference between the present maximum magnitude of deceleration and the present minimum magnitude of deceleration into a set of deceleration intervals, wherein the number of deceleration intervals in the set of deceleration intervals corresponds to the number of lights in the array of lights.

8. The brake light system of claim 7, wherein the computer executable instructions for activating one or more lights in the array of lights includes instructions for activating lights in the first section and the second section based on how many deceleration intervals are needed to equal or exceed the magnitude of deceleration in the signal received by the controller from the accelerometer.

9. The brake light system of claim 1, further comprising a filter cooperating with the accelerometer to reduce noise in the measurement of the magnitude of deceleration of the vehicle.

10. The brake light system of claim 1, wherein the array of lights includes a light emitting diode.

11. The brake light system of claim 1, wherein the controller includes computer executable instructions for activating one or more lights in the array of lights based on receiving a signal communicating that a brake pedal of the vehicle has been pressed.

12. The brake light system of claim 11, wherein:
the array of lights is disposed in row;
the row has a midline dividing the array of lights into a first section and a second section;
the first section and the second section have an equal number of lights; and
the computer executable instructions for activating one or more lights in the array of lights based on receiving a signal communicating that a brake pedal of the vehicle has been pressed includes instructions for simultaneously activating only a first inner light closest to the midline in the first section and a second inner light closest the midline in the second section.

13. The brake light system of claim 1, wherein the array of lights is circular.

14. The brake light system of claim 13, wherein the array of lights includes a first ring of lights and a second ring of lights radially spaced from the first ring of lights and with a larger circumference than the first ring of lights.

15. The brake light system of claim 14, wherein the computer executable instructions for activating one or more lights in the array of lights based on the deceleration signal received from the accelerometer includes instructions for activating only the first ring of lights when the magnitude of deceleration is below a predetermined threshold and for activating both the first ring of lights and the second ring of lights when the magnitude of deceleration is at or above the predetermined threshold.

16. The brake light system of claim 14, wherein the controller includes computer executable instructions for activating one or more lights in the array of lights based on receiving a signal communicating that a brake pedal of the vehicle has been pressed.

17. The brake light system of claim 16, wherein the computer executable instructions for activating one or more lights in the array of lights based on receiving a signal communicating that a brake pedal of the vehicle has been pressed includes instructions for activating just the first ring of lights when the controller receives the signal communicating that the brake pedal of the vehicle has been pressed and the magnitude of deceleration communicated to the controller by the accelerometer is below a pre-determined threshold.

18. A brake light system tor a vehicle comprising:
an array of lights attached to the vehicle;
an accelerometer configured to measure a magnitude of deceleration of the vehicle and to transmit a deceleration signal communicating the magnitude of deceleration of the vehicle;
a brake pedal sensor configured to detect when a brake pedal of the vehicle is pressed and to transmit a pedal engaged signal communicating that the brake pedal has been pressed; and
a controller in electronic communication with the array of lights, the accelerometer, and the brake pedal sensor, the controller including computer executable instructions tor activating one or more lights in the array of lights based on one or more of the deceleration signal received from the accelerometer and the brake pedal engaged signal received from the brake pedal sensor;
wherein the number of lights activated corresponds to the magnitude of deceleration of the vehicle.

19. The brake light system of claim 18, wherein computer executable instructions for activating one or more lights in the array of lights includes instructions for activating selected lights in the array of lights when die controller receives die signal communicating that die brake pedal of the vehicle has been pressed and the magnitude of deceleration communicated to the controller by the accelerometer is below a pre-determined threshold.

20. The brake light system of claim 19, wherein the selected lights in the array of lights are proximate a central point of the array of lights.
